(19) United States
(12) Patent Application Publication
(10) Pub. No.: US 2007/0133035 A1
(43) Pub. Date: Jun. 14, 2007

(54) Image-forming apparatus, image-processing apparatus, confidential document reading method, image-processing method, and image-forming method

(75) Inventors: Shin Kondo, Kanagawa (JP); Tadaomi Suzuki, Kanagawa (JP); Junichi Matsunoshita, Kanagawa (JP); Hiroshi Hayashi, Kanagawa (JP); Tsutomu Kimura, Kanagawa (JP); Mitsugu Kamio, Kanagawa (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 11/454,890

(22) Filed: Jun. 19, 2006

(30) Foreign Application Priority Data
Dec. 13, 2005 (JP) 2005-359647

(51) Int. Cl. G06K 15/00

(52) U.S. Cl. 358/1.14; 358/449

(57) ABSTRACT

An image-forming apparatus includes a reading portion that reads an image of an original document, a detecting portion that detects a specific pattern image embedded in image data, a document size detecting portion that detects a size of the original document, and a controller that controls an output of the image data in accordance with the specific pattern image, and also controls not to output the image data if the size of the original document detected is smaller than a given size.

### CROSS-REFERENCE TO RELATED APPLICATION

This application claims priority under 35 USC 119 from Japanese patent document, 2005-359647, the disclosure of which is incorporated by reference herein.

### BACKGROUND

1. Technical Field

This invention generally relates to a technique of preventing unauthorized copying of image of an original document.

2. Related Art

In recent years, thanks to the wide spread use of image-forming apparatuses having copying functionality such as personal computers, printers, and copying machines, it is very easy to make a copy of document. Under the circumstances, however, there is a drawback in that it is easy to make a copy of manuscript or original document that owns the copyright or that should be prohibited from unauthorized copying when it is defined as “copy inhibit”, “strict prohibition of copying”, or “secret” (hereinafter, simply referred to as “confidential document”). In other words, there arises a problem of leakage of critical information (secret content) by unauthorized duplication in outputting of a printed material (print out) of the “confidential document”, namely, the document which includes a character string, figure, table, graphic form, and the like, and from which leakage of the critical information should be prevented. Accordingly, an image-forming apparatus having a functionality of copying is demanded for having the functionality of preventing duplication abuse of the confidential document.

### SUMMARY

According to an aspect of the invention, there is provided an image-forming apparatus including: a reading portion that reads an image of an original document; a detecting portion that detects a specific pattern image embedded in image data; a document size detecting portion that detects a size of the original document; and a controller that controls an output of the image data in accordance with the specific pattern image, and also controls not to output the image data if the size of the original document detected is smaller than a given size.

### BRIEF DESCRIPTION OF THE DRAWINGS

Embodiments of the present invention will be described in detail based on the following figures, wherein:

FIG. 1 is a block diagram showing a configuration of an image-forming apparatus according to an exemplary embodiment of the present invention;

FIG. 2 is a view illustrating an original document-mounting portion according to an exemplary embodiment of the present invention;

FIG. 3 illustrates a tint block background image according to an exemplary embodiment of the present invention;

FIG. 4 shows a configuration of a copyright inhibit information detecting portion according to an exemplary embodiment of the present invention;

FIG. 5A through FIG. 5C show examples of images use for plate matching according to an exemplary embodiment of the present invention;

FIG. 6 is a block diagram showing a configuration of a copy permit condition information detecting portion according to an exemplary embodiment of the present invention;

FIG. 7 is a block diagram showing a configuration of a tint block background image generating portion according to an exemplary embodiment of the present invention;

FIG. 8A through FIG. 8C show copy inhibit information and condition information according to an exemplary embodiment of the present invention;

FIG. 9A and FIG. 9B show pattern number sequences according to an exemplary embodiment of the present invention;

FIG. 10 is a flowchart of operation procedure according to an exemplary embodiment of the present invention;

FIG. 11 is a flowchart of operation procedure according to an exemplary embodiment of the present invention; and

FIG. 12 is a flowchart of operation procedure according to an exemplary embodiment of the present invention.

### DETAILED DESCRIPTION

A description will now be given, with reference to the accompanying drawings, of embodiments of the present invention.

### First Embodiment

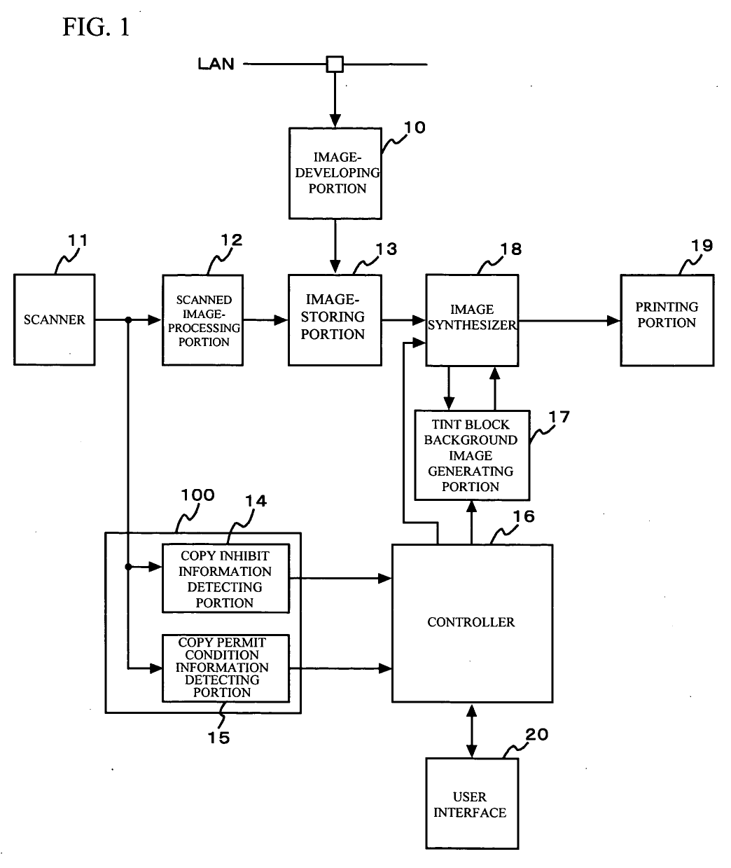

Referring to FIG. 1, first, a configuration employed in the present embodiment is described. An image-forming apparatus 1 employed in the present embodiment shown in FIG. 1 includes an image-developing portion 10, a scanner 11, a scanned image-processing portion 12, an image-storing portion 13, a copy inhibit information detecting portion 14, a copy permit condition information detecting portion 15, a controller 16, a tint block background image generating portion 17, an image synthesizer 18, a printing portion 19, and a user interface 20. The copy inhibit information detecting portion 14 and the copy permit condition information detecting portion 15 serve as an additional information detecting portion 100.

The image-developing portion 10 inputs print data described in print description language (PDL), through a network such as a LAN or the like. The image-developing portion 10 performs a developing operation on such input print data to produce image data. Such produced image data is output to the image-storing portion 13 to store therein.

The scanner 11 reads an original document placed on a platen glass, and outputs such read image data to the scanned image-processing portion 12.

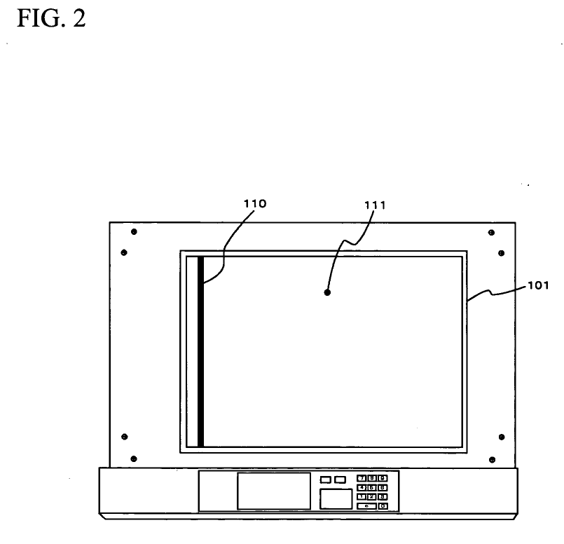

The scanner 11 is provided with a document size detecting portion that obtains a size of the original document. FIG. 2 is a view illustrating a configuration of a document-mounting portion 101. A main scanning direction detecting sensor 110 is made up, for example, of a charge-coupled device (CCD). Immediately before the original document is covered with a platen cover that presses the original document or in a case where the platen cover is kept open, the main scanning direction detecting sensor 110 reads only one line of the image data of the original document mounted at a given location of the document-mounting portion 101 in order to determine the original document size of the main scanning direction, on the basis of the number of pixels of the image data of the original document. Also, a subsidiary scanning direction detecting sensor 111 is made up, for example, of a specific reflective sensor, and senses whether or not there is a document mounted on the document-mounting portion 101. An original document size determining portion, not shown, detects edge positions of the original document from the image data of the original document to be read by the main scanning direction detecting sensor 110, determines a length of a main scanning direction of the original document mounted on the document-mounting portion 101 with the number of pixels between the edge positions of the original document, and determines the original document size on the basis of the length of the main scanning direction of the original document and whether or not there is a document mounted on the document-mounting portion 101 that has been detected by the subsidiary scanning direction detecting sensor 111.

The scanned image-processing portion 12 performs color correction, color space conversion, and screen treatment on the input image data, and stores the image data after image processing in the image-storing portion 13.

The image synthesizer 18 reads the image data from the image-storing portion 13, and outputs the image data to the printing portion 19. In addition, when it is set by the controller 16 to synthesize a tint block background image, the image synthesizer 18 reads the tint block background image data stored in a memory of the image synthesizer 18 in synchronization with reading the image data from the image-storing portion 13, synthesizes a given color plane of the image data with the use of a logical operation (OR), and outputs such synthesized image data to the printing portion 19. The printing portion 19 records the synthesized image data output from the image synthesizer 18 or the image data on a paper.

The image-forming apparatus employed in the present embodiment is configured in such a manner that only the additional information embedded in the tint block background image is read from the confidential document having the tint block background embedded therein, and only the authorized user is able to print out the confidential document. The additional information to be embedded in the tint block background information is described below.

(A) . . . Copy inhibit information (whether copying is inhibited or not)

(B) . . . Copy permit condition information (information that authorizes copying when a condition is matched). Examples are password, user ID number having a copy permission (such as employee ID number), time and date when copy inhibition is terminated, machine number of a copying machine by which copying is allowed, and the like.

(C) . . . Latent image information (information on a latent image that becomes visible when copied). Examples are a character string of the latent image, font type, font size, direction (angle) of the character string of the latent image, color of tint block background image, and the like.

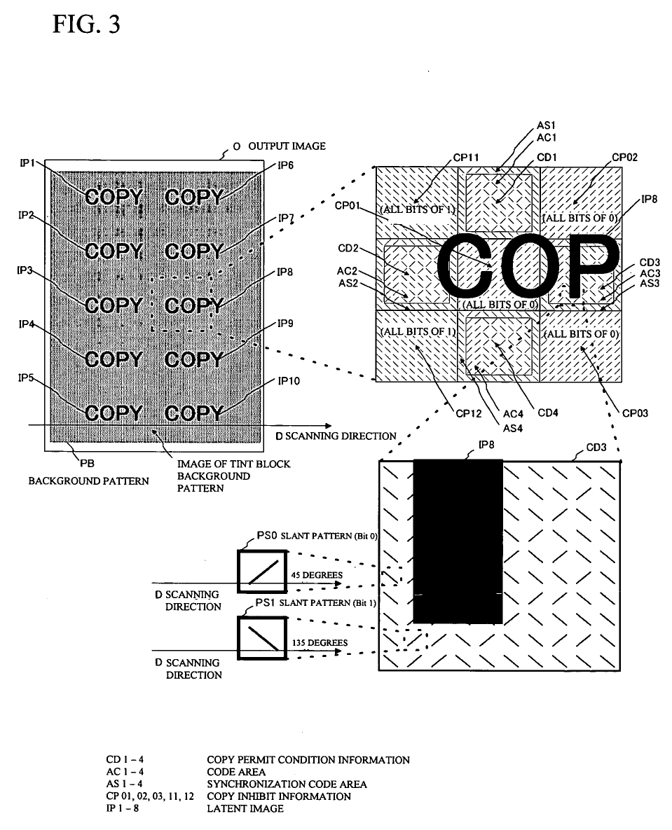

Referring now to FIG. 3, the tint block background image is described in detail. A tint block background image includes a latent image IP and a background pattern PB.

The background pattern PB and the latent image IP respectively have different patterns. However, an output image o is formed of patterns having identical pixel areas and pixel colors per unit area so that the background looks gray colored uniformly on a whole surface to human eyes.

The latent image IP is composed of smaller dots than other portions in a copied document so that the latent image IP is visible and can be distinguished by human eyes.

The background pattern PB is composed of codes. The codes are composed of a condition code CD representing arbitrary code data and a copy inhibit code CP restricting copying or duplication.

Each of the codes is composed of a slant pattern PS representing arbitrary code data. The slant pattern PS represents bit 0 in a half line slanted at 45 degrees counterclockwise relative to a scanning direction D, and represents bit 1 slanted at 135 degrees.

The copy inhibit code CP is composed of the slant pattern PS representing bit 0 (PS0) and the slant pattern representing bit 1 (PS1). The copy inhibit code CP is used for determining that copying the original document is restricted in a case where more than a given number of two kinds of the copy inhibit codes CP are detected.

The condition code CD is composed of a synchronization code area AS and a data code area AC. The synchronization code area AS denotes a code area where the outer circumference of a rectangular area of a given size surrounding the data code area AC is composed of all the slant patterns PS1. In the data code area AC, embedded are coded password, user ID number having a copy permission (such as employee ID number), time and date when copy inhibit is terminated, machine number of a copying machine by which copying is allowed, and the like, as the condition code CD.

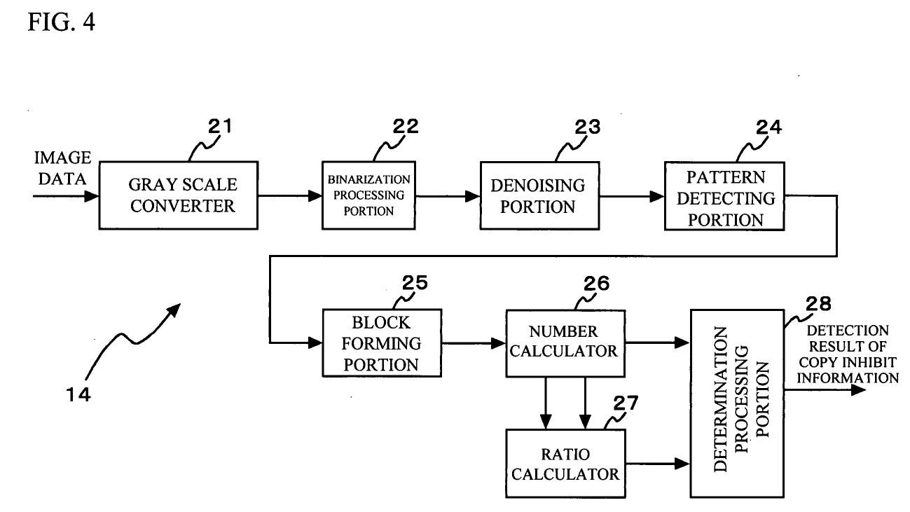

Next, referring now to FIG. 4, the copy inhibit information detecting portion 14 is described. FIG. 4 shows a configuration of the copy inhibit information detecting portion 14 in detail. The image data output from the scanner 11 is input into a gray scale converter 21 to convert full color into gray scale. Subsequently, a binarization processing portion 22 binarizes the image data.

Such binarized image data is input into a denoising portion 23 to perform a denoising operation. Specifically, a mass of pixels in which black pixels are connected is obtained. If the size of the mass of the black pixels (number of connected pixels) is not included within a given range, each of the pixels is replaced by a white pixel. The afore-mentioned given range is configured appropriately such that the slant patterns are not removed and other patterns, such as an isolated dot pattern or a character or figure in the document, are removed.

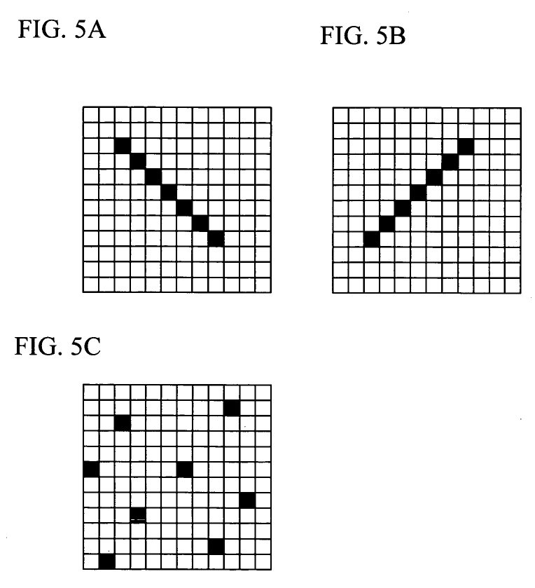

The denoised image data is input into a pattern detecting portion 24 to detect the two kinds of slant patterns. As a result, the image data having two bits per pixel is output. More specifically, detection is carried out by template matching of comparing patterns shown in FIG. 5A and FIG. 5B in a position of each pixel of the image data. Here, when a pattern (A) of FIG. 5A is detected, a pixel value 0 is output. When a pattern (B) of FIG. 5B is detected, a pixel value 1 is output. When no pattern is detected, a pixel value 2 is output.

The image data output from the pattern detecting portion 24 is input into a block forming portion 25. Here, it is configured in such a manner that a size of a block is smaller than a half the size of the copy inhibit code CP or that of the condition code CD, and one or more blocks are completely included in a code. The block forming portion 25 divides the input image data into blocks respectively having a given size, and outputs the blocks to a number calculator 26.

The number calculator 26 respectively calculates the number of pixels having the pixel value 0 and that of pixels having the pixel value 1 in a block, and outputs the results to a ratio calculator 27 and a total number thereof to a determination processing portion 28. The ratio calculator 27 calculates a ratio of the pixels having the pixel value 0, and outputs the result to the determination processing portion 28.

The determination processing portion 28 implements a determination process on the basis of the total number input from the number calculator 26 and the ratio input from the ratio calculator 27.

Here, assuming that the block being currently processed is positioned in the copy inhibit code CP having all bits of 0, a given number or more slant patterns PS representing bit 0 are detected in the block, and the slant pattern PS representing bit 1 is scarcely detected. Accordingly, the ratio of the slant pattern PS representing bit 0 should be high and close to almost 1.0.

Also, assuming that the block being currently processed is positioned in the copy inhibit code CP having all bits of 1, a given number or more slant patterns PS representing bit 1 are detected in the block, and the slant pattern PS representing bit 0 is scarcely detected. Accordingly, the ratio of the slant pattern PS representing bit 0 should be low and close to almost 0.0.

Additionally, assuming that the block being currently processed includes at least a portion of the condition code CD, multiple slant patterns PS representing bit 0 and multiple slant patterns PS representing bit 1 are detected in the block. Accordingly, the ratio of the slant pattern PS representing bit 0 should be considerably lower than 1.0 and considerably higher than 0.

Furthermore, if the copy inhibit information is embedded in the input image data, there should be respectively multiple copy inhibit codes CP having all the bits of 0 embedded in a block and multiple copy inhibit codes CP having all the bits of 1 embedded in a block.

With the characteristics described heretofore, the determination process is implemented as follows.

In a case where the total number is greater than a first threshold value and the ratio is greater a second threshold value, it is determined that the block is a copy inhibit code of 0.

In a case where the total number is greater than the first threshold value and (1—the ratio) is greater than the second threshold value, it is determined that the block is a copy inhibit code of 1.

In other cases, it is determined that the block is not a copy inhibit code. The first threshold value is set by adding a margin to a pattern number included in the block from the block size and pattern size. The second threshold value is set to a value close to 1.0.

The determination processing portion 28 separately counts the number of blocks determined to be the copy inhibit code of 0 and the number of blocks determined to be the copy inhibit code of 1. In a case where the number of blocks determined to be the copy inhibit code of 0 has a threshold value equal to or more than 3 and the number of blocks determined to be the copy inhibit code of 1 has a threshold value equal to or more than 3, it is determined that the image is a copy inhibit document, and outputs the determination result to the controller 16.

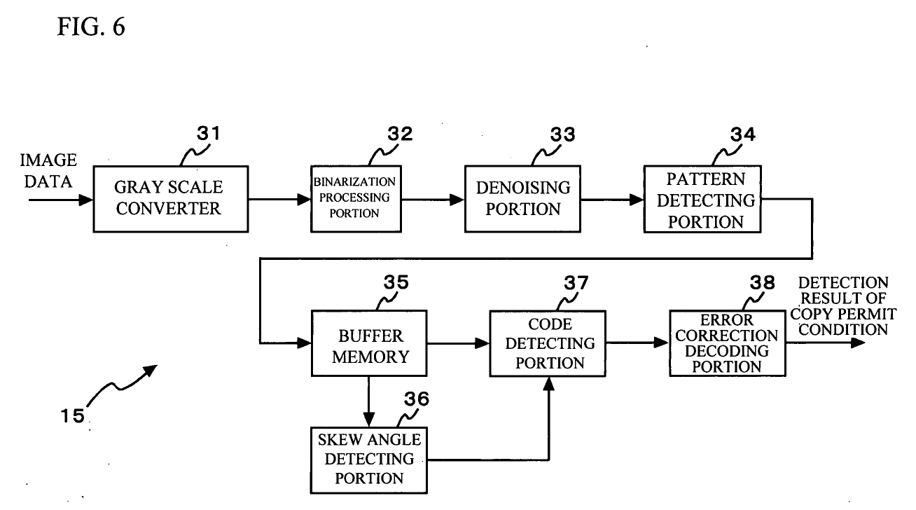

Next, referring to FIG. 6, a description is given of the copy permit condition information detecting portion 15 in detail. The image data output from the scanner 11 is input into a gray scale converter 31. After the image data is converted into gray scale from full color, a binarization processing portion 32 binarizes the image data.

Such binarized image data is input into a denoising portion 33 to perform a denoising operation. The denoised image data is input into a pattern detecting portion 34 to detect the two kinds of slant patterns. Data of the results are stored in a buffer memory 35. The image data has two bits per pixel. The pixel value is 0 at a position if the slant pattern representing bit 0 is detected, the pixel value is 1 at a position if the slant pattern representing bit 1 is detected, and the pixel value is 2 at other positions.

The image data stored in the buffer memory 35 is input into a skew angle detecting portion 36, and a skew angle is detected. Here, the skew angle of the input image data is obtained. As a concrete method, Hough Transformation is performed on only the pixel having a pixel value of 0 or 1 and a peak of the projection distribution on the angular axis is obtained. Such obtained skew angle is output to a code detecting portion 37.

Also, the image data stored in the buffer memory 35 starts to be read, and is input into the code detecting portion 37. Specifically, the pixel value of 0 or 1 (corresponding to the bit 0 or 1) is acquired by scanning the image at such obtained skew angle. A synchronization code is found from such acquired bit sequence. The synchronization code is defined as a code composed of all the bits of 1 in the perimeter of the rectangular area having given vertical and horizontal sizes. The bit sequence surrounded by the synchronization code is a two-dimensional code (condition code). This bit sequence is rearranged into one-dimensional bit sequence to output to an error correction decoding portion 38.

In the error correction decoding portion 38, a given error correction decoding process is performed on the input bit sequence to decode as condition information. The decoded copy permit condition information is output to the controller 16.

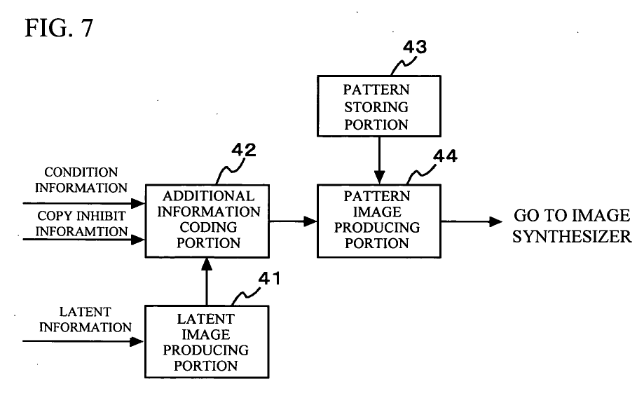

Next, referring to FIG. 7, a description is given to the tint block background image generating portion 17. The additional information (the copy inhibit information, the copy permit condition information, and the latent image information) is input into the tint block background image generating portion 17 from the controller 16. Among the information, the copy inhibit information and the copy permit condition information are input into an additional information coding portion 42, and the latent information is input into a latent image producing portion 41.

The latent image producing portion 41 produces the latent image on the basis of such input latent image information. The latent image information is information representing what kind of a latent character is to be embedded in the pattern image. Specifically, the latent image information is composed of the character string of the latent image, the font type thereof, the font size thereof, the direction (angle) of the character string of the latent image, and the like. Upon receiving the latent image information, the latent image producing portion 41 renders the character string of the latent image in a designated direction with a designated font type and font size, to produce a binary latent image. Such produced latent image is output to the additional information coding portion 42. The resolution of the latent image is calculated by dividing a printer resolution by a pattern size, which will be described later. An example is that the resolution of the latent image is 50 dpi, where the printer resolution is 600 dpi and the pattern size is 12 pixels×12 pixels.

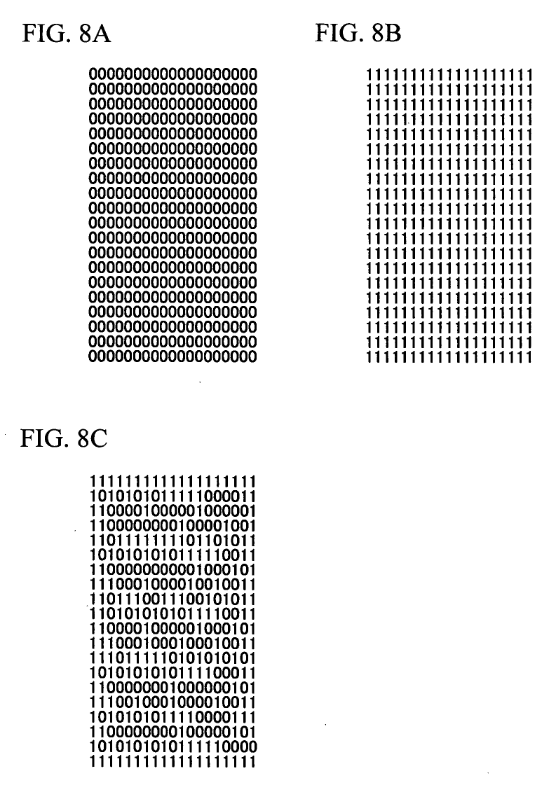

The additional information coding portion 42 encodes the copy inhibit information and the condition information that have been input. Firstly, when the copy inhibit information represents that the document that has been printed out is inhibited from being copied on the image-forming apparatus, two kinds of copy inhibit codes are produced as shown in FIG. 8A and FIG. 8B. Here, it is noteworthy that the copy inhibit code of FIG. 8A has all the bits of 0 in the code, and the copy inhibit code of FIG. 8B has all the bits of 1 in the code. If the copy inhibit information is not input, or if the information does not mean that the printed document is inhibited from being copied on the image-forming apparatus, the two kinds of codes of FIG. 8A or FIG. 8B are not produced.

Next, if the condition information is input, error correction is performed on the condition information and a condition code shown in FIG. 8C is produced. The code of FIG. 8C represents a bit sequence of the coded condition information with the arrangement of the bits 0 and bits 1. The perimeter of the code has a specific bit pattern to facilitate the code positioning.

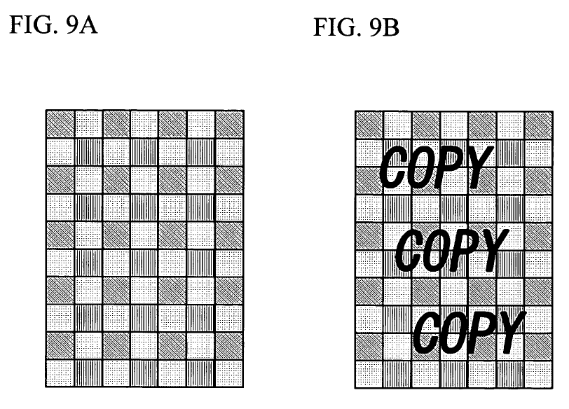

Subsequently, multiple produced codes are arranged repeatedly as shown in FIG. 9A to produce a pattern number sequence having a size identical to that of the latent image. Here, a slanted hatched rectangle indicates the copy inhibit code of FIG. 8A. A vertical hatched rectangle indicates the copy inhibit code of FIG. 8B. A dotted hatched rectangle indicates the condition code of FIG. 8C. Unless the copy inhibit code is produced, the condition code is arranged instead of the copy inhibit code in figures. Unless the condition code is produced, the copy inhibit code is arranged instead of the condition code. At this time, each element has a value of 0 or 1 in the pattern number sequence.

Then, referring to the latent image, a pattern number of the pattern number sequence that corresponds to a coordinate of a black pixel in the latent image is changed to 2. When this process is performed on all the black pixels in the latent image, the pattern number sequence becomes a state where a latent character is drawn by a pattern number 2 on the background where the copy inhibit codes and the condition codes are arranged. This state is shown in FIG. 9B. “COPY” drawn in black in FIG. 9B is a portion in which the pattern number sequence is changed to 2. The pattern number sequence is output to a pattern image producing portion 44.

The pattern image producing portion 44 refers to each element of the pattern number sequence that has been input, reads a pattern that corresponds to the pattern number sequence from a pattern storing portion 43 to convert into the pattern image, and produces the tint block background image. Such produced tint block background image is stored in a memory, not shown, of the image synthesizer 18.

When the image-forming apparatus 1 employed in the present embodiment reads an image of the original document in which the additional information is embedded and controls print out according to the additional information, the image-forming apparatus forces to stop reading the image of the original document, if the size of the image of the original document is smaller than a given size. In a case where the size of the image of the original document is smaller than a given size, the number of pieces of the additional information is smaller accordingly and the number of pieces of the additional information that can be detected by the copy inhibit information detecting portion 14 is smaller. For this reason, in the present embodiment, if the size of the original document detected by the copy inhibit information detecting portion 14 is smaller than a given size, the controller 16 outputs a read stop instruction to the scanner 11.

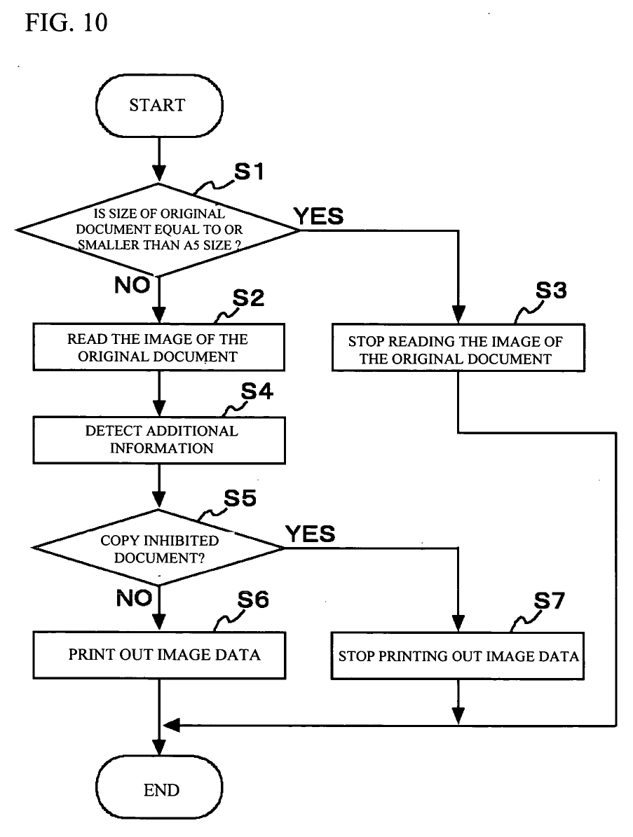

With reference to a flowchart shown in FIG. 10, the procedure used in the present embodiment is described. Here, as an example, if the original-document size is equal to or smaller than A5, it is configured to stop reading the image of the original document. However, another size may be employed for the given size. An original document size detecting portion provided in the scanner 11 detects the size of the original document placed on the document-mounting portion 101. Then, the controller 16 determines whether or not the original document size is equal to or smaller than A5 size (at step S1). If the original document size is equal to or smaller than A5 size (YES/step S1), the read stop instruction for the image of the original document is output to the scanner 11 (at step S3).

If the original document size is greater than A5 size (NO/step S1), the scanner 11 reads the image of the original document (step S2), and detects the additional information embedded in the image of the original document (at step S4). If the copy inhibit information inhibits the original document from making a copy (YES/step S5), the controller 16 stops outputting the image data to the printing portion 19, and stops printing out (at step S7). In addition, if the original document does not include the copy inhibit information (NO/step S5), the image data is read from the image-storing portion 13 to output to the printing-portion 19 and the image data is printed out from the printing portion 19 (at step S6).

As stated heretofore, if the original document size is equal to or smaller than a given size, it is configured that print out of the image data is stopped. Accordingly, the original document that is set as the copy inhibit is not mistakenly copied.

### Second Embodiment

In the above-described embodiment, print out of the image is stopped, if the original document size is equal to or smaller than a given size. However, in the present embodiment, a threshold value that determines whether or not the additional information is embedded is changed according to the original document size. It is configured such that a small-sized original document is set to have a small determination threshold value, and on the contrary, a large-sized original document is set to have a large determination threshold value. The small-sized original document has a small number of pieces of the information embedded in the original document accordingly, therefore limiting the number of pieces of additional information that can be detected. For this reason, the detection accuracy of the additional information is enhanced by reducing the determination threshold value. Also, if the original document is large in size and the information of the image close to the additional information is printed, there is a possibility of misdetection. For this reason, the large-sized original document is set to have a large determination threshold value.

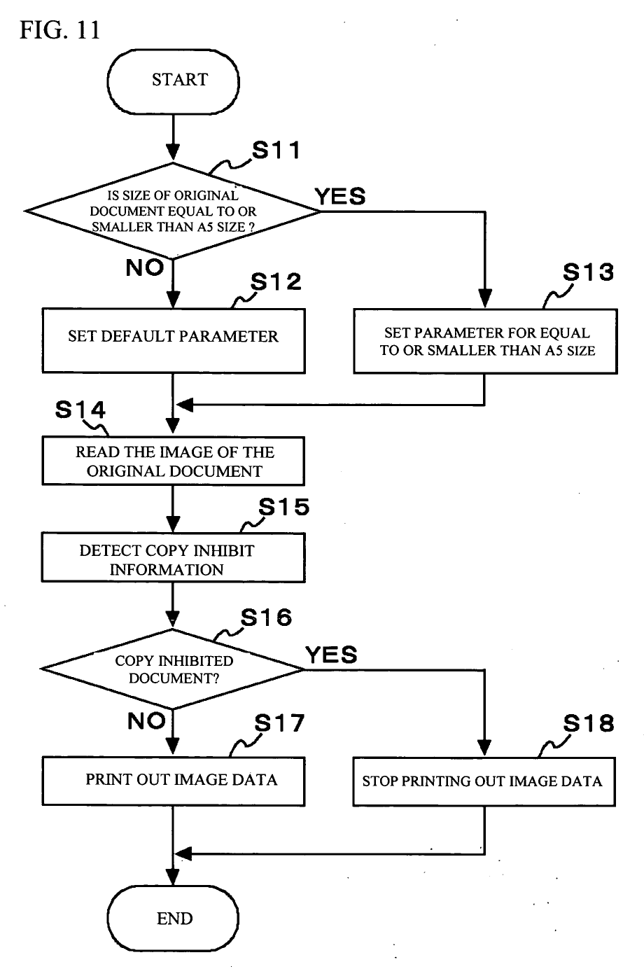

With reference to a flowchart shown in FIG. 11, the procedure used in the present embodiment is described. The original document size detecting portion provided in the scanner 11 detects the size of the original document placed on the document-mounting portion 101. Then, the controller 16 determines whether or not the original document size is equal to or smaller than A5 size (at step S11). If the original document size is equal to or smaller than A5 size (YES/step S11), the determination threshold value for the original document equal to or smaller than A5 is set at the copy inhibit information detecting portion 14 (at step S13).

If the original document size is greater than A5 size (NO/step S11), a predetermined default determination threshold value is set at the copy inhibit information detecting portion 14 (at step S12).

Subsequently, the scanner 11 reads the image of the original document (step S14), and detects the additional information embedded in the image of the original document (at step S15). At this time, if the size of the original document is equal to or smaller than A5 size, the copy inhibit information detecting portion 14 determines the additional information with the use of the determination threshold value for the original document equal to or smaller than A5. If original document is greater than A5 size, the copy inhibit information detecting portion 14 determines the additional information with the use of the default determination threshold value.

If the copy inhibit information inhibits the original document from making a copy (YES/step S16), the controller 16 stops outputting the image data to the printing portion 19, and stops print out (at step S18). Also, if the original document does not include the copy inhibit information (NO/step S16), the image data is read from the image-storing portion 13 to output to the printing portion 19 and the image data is printed out from the printing portion 19 (at step S17).

In addition to the copying operation, a print operation may be stopped, when a paper having a size equal to or smaller than, for example, A5 is selected and print out of the confidential document having the copy inhibit information embedded therein is set for forming the image on the image-forming apparatus 1.

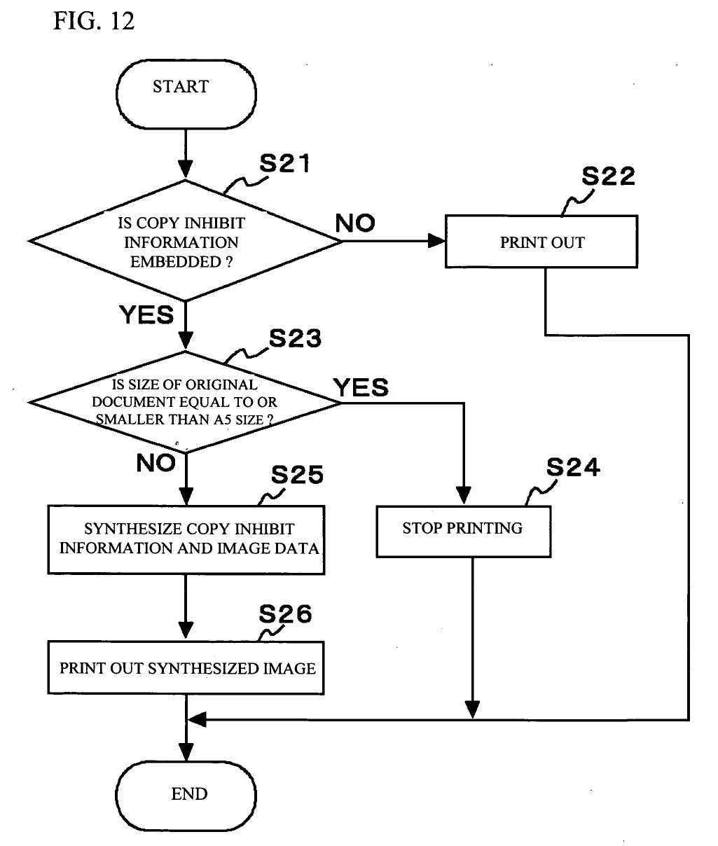

This procedure is described with reference to a flowchart shown in FIG. 12. If a print instruction is input from the user interface 20, the controller determines whether it is a print out of the image (of the confidential document) having the copy inhibit information embedded therein (at step S21). If it is not a print out of the confidential document (NO/step S21), the designated image is output to the printing portion 19 without change and printing is carried out (at step S22).

If the controller 16 determines that it is a print out of the confidential document (YES/step S21), the controller 16 further determines whether or not the paper size is equal to or smaller than a given size (for example, A5) (at step S23). If the paper size is equal to or smaller than the given size (YES/step S23), the controller 16 controls each portion to stop the print operation. If the paper size is greater than the given size (NO/step S23), the copy inhibit information is synthesized with the image data (at step S24) and printed out by the printing portion 19 (at step S26).

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image-forming apparatus comprising:
a reading portion that reads an image of an original document;
a detecting portion that detects a specific pattern image embedded in image data;,
a document size detecting portion that detects a size of the original document; and
a controller that controls an output of the image data in accordance with the specific pattern image, and also controls not to output the image data if the size of the original document detected is smaller than a given size.

2. An image-forming apparatus comprising:
a reading portion that reads an image of an original document;
a detecting portion that detects a specific pattern image embedded in image data;
a document size detecting portion that detects a size of the original document; and
a controller that controls an output of the image data in accordance with the specific pattern image, and also changes a threshold value that determines whether or not the specific pattern image is embedded in the original document in accordance with the size of the original document.

3. The image-forming apparatus according to claim 1, wherein the controller does not output the image data, if the size of a paper on which an image is to be formed is smaller than a given size.

4. An image-forming apparatus comprising:
a synthesizing portion that synthesizes an original document and a control code that restricts a duplication of the original document;
an image-forming portion that forms an image of image data having the control code synthesized by the synthesizing portion; and
a controller that stops an operation of the image-forming apparatus, if it is determined that a size of a paper to which an image is to be output is smaller than a given size.

5. An image-forming apparatus comprising:
a detecting portion that detects a specific pattern image embedded in image data; and
a controller that controls an output of the image data in accordance with the specific pattern image, and also controls not to output the image data if a size of an original document in which the image data is stored is smaller than a given size.

6. A confidential document reading method comprising:
detecting a size of an original document;
reading an image of the original document;
detecting a specific pattern image embedded in image data;
controlling an output of the image data in accordance with the specific pattern image; and
controlling not to output the image data if the size of the original document detected is smaller than a given size.

7. A confidential document reading method comprising:
detecting a size of an original document;
reading an image of the original document;
detecting a specific pattern image embedded in image data;
controlling an output of the image data in accordance with the specific pattern image; and
changing a threshold value that determines whether or not the specific pattern image is embedded in the original document in accordance with the size of the original document.

8. An image-processing apparatus comprising:
detecting a specific pattern image embedded in image data;
controlling an output of the image data in accordance with the specific pattern image; and
controlling not to output the image data if a size of the original document in which the image data is stored is smaller than a given size.

9. An image-forming method comprising:
synthesizing an original document and a control code that restricts a duplication of the original document;
forming an image of image data having the control code synthesized by the synthesizing portion; and
controlling to stop an operation of an image-forming apparatus, if it is determined that a size of a paper to which an image is to be output is smaller than a given size.
